(19) United States
(12) Patent Application Publication
(10) Pub. No.: US 2018/0089921 A1
(43) Pub. Date: Mar. 29, 2018

(54) GENERATING A CIVIC GRAPH AND ENHANCING USER INTERACTIONS PERFORMED WITHIN A COMMUNICATION SYSTEM

(71) Applicant: Facebook, Inc., Menlo Park, CA (US)

(72) Inventors: Kaushik Mohan Iyer, San Mateo, CA (US); Samidh Chakrabarti, Palo Alto, CA (US); Ellora Thadaney Israni, Cambridge, MA (US); Guangxishui Yang, New York, NY (US)

(21) Appl. No.: 15/280,168

(22) Filed: Sep. 29, 2016

(51) Int. Cl. G07C 13/00

(52) U.S. Cl. CPC G07C 13/00; G06Q 50/01

(57) ABSTRACT

Exemplary methods, apparatuses, and systems generate a civic graph of users within a communication system. Using connections formed within the civic graph, the communication system recommends additional connections between nodes representing constituents and nodes representing political office holders. For example, a request is received from a first user of a communication system to interact with a second user of the communication system. A first node representing the second user is determined to be connected to a second node representing a political office by a first edge, the first edge representing that the second user holds the political office represented by the second node. In response to the received request and the determination that the second user holds the political office, a recommendation is transmitted to the first user, including one or more interface objects enabling the first user to interact with another political office holder in the civic graph.

### FIELD

The various embodiments described herein relate to generating and publishing content to a communication system, such as a social networking system. In particular, the embodiments relate to generating a civic graph and a social ballot to suggest and facilitate interactions with politically-themed users and/or content within the communication system.

### BACKGROUND

Communication systems enable users to interact with various objects represented within the communication system. For example, a communication system in the form of a social networking system allows users to designate other users or entities as connections (or otherwise connect to, or form relationships with, other users or entities), contribute and interact with their connections, post media or commentary, share links to external content, use applications, join groups, list and confirm attendance at events, invite connections, and perform other tasks that facilitate social interaction. External applications also use the services of a social networking system to allow authenticated users to incorporate some of the above social interactions with use of the external applications. Similar interactions may also be a part of the user experience within other network services.

### SUMMARY OF THE DESCRIPTION

Exemplary methods, apparatuses, and systems for generating civic graphs and social ballots are detailed herein.

In one embodiment, a communication system generates a civic graph of users within the communication system to create and recommend connections between nodes representing constituent users and nodes representing political office holders. For example, based on a connection between a node for a user and a node for a political office holder, the communication system determines one or more other political office holder that represents the user, and recommends to the user to form a new connection with the one or more other political office holder.

In another embodiment, the communication system generates a social ballot for a user based on identifying users that are impacted by a political issue and determining responses to a question regarding the political issue from other users of the communication system. The communication system generates the social ballot to include the responses of the other users that have met a threshold level of affinity with the user and content shared by the other users within the communication system. The communication system then transmits the social ballot to the user as a graphical user interface.

Other features and advantages will be apparent from the accompanying drawings and the detailed description.

### BRIEF DESCRIPTION OF THE DRAWINGS

The present embodiments are illustrated by way of example and not limitation in the figures of the accompanying drawings, in which like references indicate similar elements, and in which:

FIG. 1 illustrates an exemplary network environment of a communication system to generate civic graphs and social ballots;

FIG. 2A illustrates an exemplary social graph of communication system data;

FIG. 2B illustrates an exemplary civic graph of communication system data;

FIG. 3 illustrates an exemplary method of generating and transmitting recommendations enabling a user to interact with political office holders;

FIGS. 4A-4C illustrate an exemplary user interface for generating and transmitting recommendations enabling a user to interact with political office holders;

FIG. 5 illustrates an exemplary user interface depicting interactions between a user and a political office holder;

FIG. 6 illustrates an exemplary method of generating and transmitting a constituents summary;

FIG. 7 illustrates an exemplary user interface displaying a constituents summary;

FIG. 8 illustrates an exemplary method of generating and transmitting a social ballot;

FIGS. 9-11 illustrate an exemplary user interface for generating and transmitting a social ballot;

FIG. 12 illustrates, in block diagram form, an exemplary processing system to generate civic graphs and social ballots.

### DETAILED DESCRIPTION

Embodiments described herein generate civic graphs and social ballots using user data within a communication system. In particular, embodiments utilize data that is associated with users of a communication system to generate a civic graph of connections between users, political office holders, political offices, and political districts. As a result, the communication system generates and shares content in a manner that encourages greater interaction amongst users of the communication system. For example, the civic graph is used to generate recommendations of other users (e.g., political office holders) a constituent user may be interested in interacting with. In another example, a constituents summary of content and topics trending amongst constituents of a particular political office holder is generated.

In other embodiments, user data within a communication system is used to generate a social ballot. By utilizing user data (e.g., location, connections), the communication system generates a social ballot that includes content related to a political issue or political question that was shared by other users of the communication system that have a connection with the user within the communication system.

In the following description, numerous specific details are set forth. However, it is understood that embodiments may be practiced without these specific details. While a communication system is used to describe embodiments of promotion configuration and facilitation, it will be understood that these concepts are generally applicable to other network services/entities, websites, etc. References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

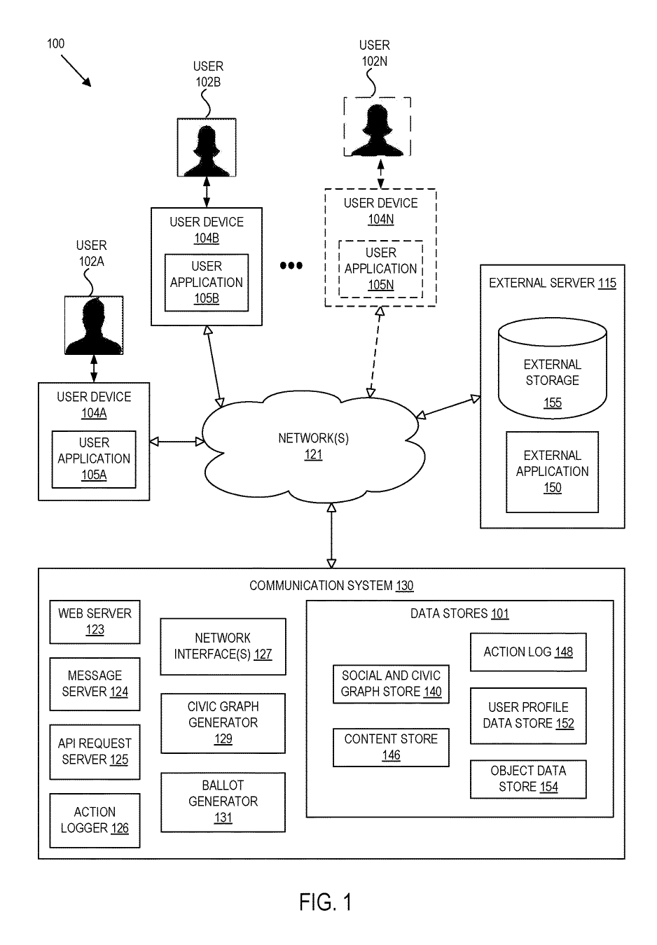

FIG. 1 illustrates an exemplary network environment of communication system 130 (or other network service) to generate civic graphs and social ballots. Communication system 130 offers its users 102A-102N the ability to communicate and interact with other users 102A-102N and entities of communication system 130 according to an embodiment.

User devices 104A-104N are enabled to interact with communication system 130 and can be any type of computing device capable of receiving user input as well as transmitting and/or receiving data via a network (e.g., network 121). Exemplary user devices 104A-104N include conventional computer systems, such as a desktop or laptop computer, or may include devices having computer functionalities such as Personal Digital Assistants (PDA), cellular or mobile telephones, smart-phones, in- or out-of-car navigation systems, gaming devices, or other electronic devices programmed to implement one or more embodiments set forth herein.

In one embodiment, a user device (e.g. 104A) may execute a user application (e.g. 105A) allowing user 102A of user device 104A to interact with communication system 130. For example, user application 105A may be a web browser application (e.g., Microsoft Windows Internet Explorer, Mozilla Firefox, Apple Safari, Google Chrome, Opera, etc.). In an embodiment, user application 105A is a special-purpose client application (e.g., Facebook for iPhone or iPad, etc.), and in an embodiment user application 105A is the native platform or operating system of user device 104A, such as Windows®, Mac OSX®, iOS®, or ANDROID™ which may utilize an Application Programming Interface (API) to directly interface with communication system 130 through API request server 125.

User devices 104A-104N are configured to communicate with communication system 130 via network 121 or a collection of networks—such as the Internet, a corporate Intranet, a Virtual Private Network (VPN), a Local Area Network (LAN), a Wireless Local Area Network (WLAN), a cellular network, a Wide Area Network (WAN), a Metropolitan Area Network (MAN), or a combination of two or more such networks. Network 121 may be wired, wireless, or a combination of both. In one embodiment, network 121 uses standard communications technologies and/or protocols. Thus, network 110 may include links using technologies such as Ethernet, Institute of Electrical and Electronics Engineers (IEEE) 802.11, Worldwide Interoperability for Microwave Access (WiMAX), 3G, 4G, Long Term Evolution (LTE), Code-Division Multiple Access (CDMA), Digital Subscriber Line (DSL), cable modems, etc. Similarly, the networking protocols used on network 110 may include Multiprotocol Label Switching (MPLS), Transmission Control Protocol (TCP), Internet Protocol (IP), TCP/IP, User Datagram Protocol (UDP), Hypertext Transport Protocol (HTTP), Simple Mail Transfer Protocol (SMTP), and/or File Transfer Protocol (FTP). Data exchanged over network 110 may be represented using technologies and/or formats including Hypertext Markup Language (HTML), Extensible Markup Language (XML), or JavaScript Object Notation (JSON), among other formats. In addition, all or some of links can be encrypted using conventional encryption technologies such as Secure Sockets Layer (SSL), Transport Layer Security (TLS), or Internet Protocol security (IPsec).

In some embodiments, communication system 130 comprises one or more computing devices storing user profiles associated with users 102A-102N and/or other objects, as well as connections between users and other users 102A-102N and/or objects. Users 102A-102N, using communication system 130, may add connections to other users or objects of communication system 130 to which they desire to be connected, and may also otherwise interact with these other users or objects. The users of communication system 130 are individuals (e.g. humans), and the objects may include entities (such as businesses, organizations, universities, manufacturers, brands, celebrities, etc.), concepts, or other non-human things including but not limited to a location, a song, an album, an article, a book, a movie, food, etc.

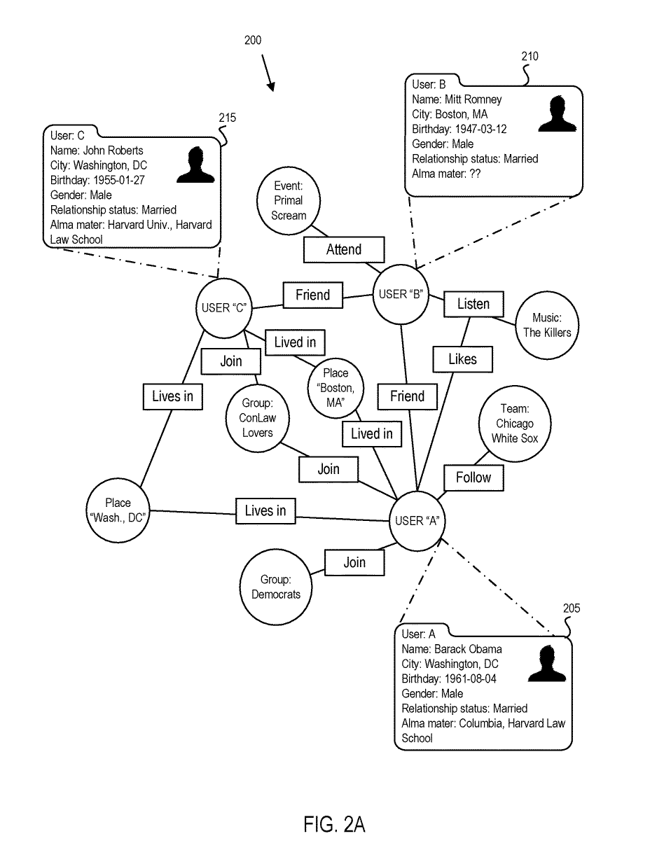

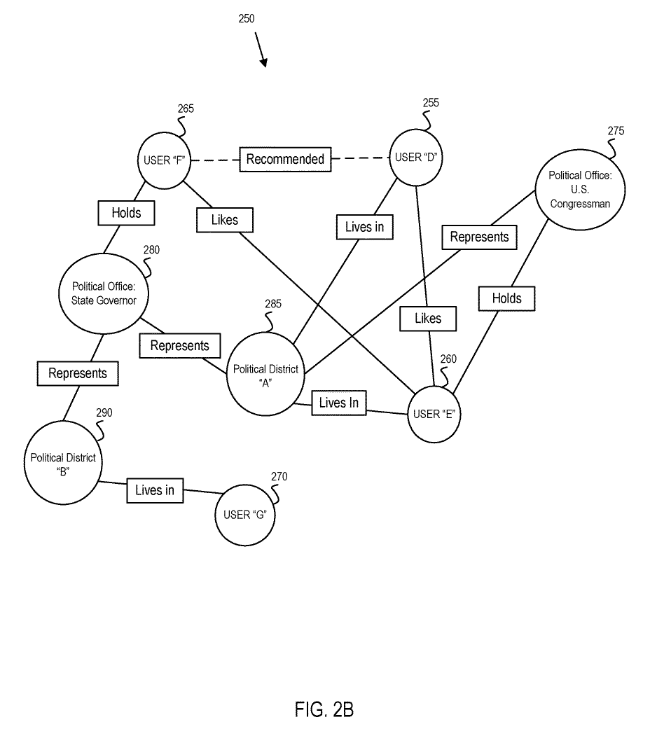

Based on the stored data about users, objects, and the connections between the users and/or objects, communication system 130 generates and maintains a “social graph” in social and civic graph store 140 comprising a plurality of nodes interconnected by a plurality of edges. Each node in the social graph represents a user or object that can act on another node and/or that can be acted on by another node. An edge between two nodes in the social graph represents a particular kind of connection between the two nodes, which may result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, communication system 130 adds, removes, or otherwise modifies edges connecting the various nodes to reflect the interactions. An exemplary social graph is described with reference to FIG. 2A.

Communication system 130 also generates and maintains a “civic graph” in social civic graph store 140 comprising a plurality of nodes interconnected by a plurality of edges. As with the social graph, each node in the civic graph represents a user or object that can act on another node and/or that can be acted on by another node. An edge between two nodes in the civic graph represents a particular kind of connection between the two nodes, which may result from an action that was performed by one of the nodes on the other node. For example, when a user “likes” or “follows” an additional user, an edge in the civic graph is generated connecting a node representing the first user and an additional node representing the additional user. As various nodes interact with each other, communication system 130 adds, removes, recommends, or otherwise modifies edges connecting the various nodes to reflect the interactions. An exemplary civic graph is described with reference to FIG. 2B. While illustrated and described separately, in one embodiment, the civic graph represents a portion of the social graph.

The embodiment of communication system 130 illustrated in FIG. 1 includes web server 123, message server 124, API request server 125, action logger 126, civic graph generator 129, ballot generator 131, and a set of data stores 101. This embodiment also includes, within the data stores 101, social and civic graph store 140, content store 146, action log 148, user profile data store 152, and object data store 154. In other embodiments, communication system 130 may include additional, fewer, or different modules for various applications. Of course, conventional components such as processors, memories, security mechanisms, load balancers, failover servers, management and network operations consoles, and the like are not shown in FIG. 1 so as to not obscure the details of the system.

Communication system 130 allows its users 102A-102N to communicate or otherwise interact with each other and access content, as described herein. Communication system 130 stores user profiles in the user profile data store 152. A user profile includes declarative information about the user that was explicitly shared by the user, and may also include profile information inferred by communication system 130. In one embodiment, a user profile includes multiple data fields, each data field describing one or more attributes of the corresponding user of communication system 130. The user profile information stored in user profile data store 152 describes users 102A-102N of communication system 130, including biographic, demographic, and other types of descriptive information, such as work experience, educational history, gender, relationship status, interests, hobbies, location, other preferences, and the like. The user profile may also store information provided by the user. For example, images or videos provided by the user may also be stored within the user profile. In other embodiments only textual data of the user is stored in the user profile and other data (e.g., images, videos) are stored in multimedia stores and associated with the user (e.g., through associating a user identifier of the user with an image/video identifier of the multimedia content). In certain embodiments, images or videos including or depicting users of communication system 130 may be “tagged” with identification information of those users. A user profile in the user profile data store 152 may also maintain references to actions (stored in the user profile or in action log 148) by the corresponding user performed on content items in content store 146. A user may also specify one or more privacy settings, which are stored in that user's user profile. Privacy settings limit information that communication system 130 or other users of communication system 130 are permitted to access from that user's user profile.

Web server 123 links communication system 130 via network 121 to one or more user devices 104A-104N by accepting requests for from user devices 104A-104N and/or transmitting web pages or other web-related content to user devices 104A-104N, such as image files, audio files, video files, Java applets, Flash, XML, JavaScript, Cascading Style Sheets (CSS), and so forth. Web server 123 in some embodiments is configured to utilize a set of one or more network interfaces 127 to send and receive messages across network 121. In some embodiments web server 123 (additionally or alternately) utilizes message server 124 (e.g., a dedicated server end station, a dedicated software application, etc.) to communicate with user devices 104A-104N, which is operative to send and/or receive instant messages, queued messages (e.g., email), text and SMS (Short Message Service) messages, or utilize any other suitable messaging technique.

In some embodiments, a message sent by a user to another user by way of communication system 130 can be viewed by other users of communication system 130, for example, by certain connections of the user (directly connected users in the social graph, other users more than one hop away in the social graph, etc.) receiving the message. An example of a type of message that can be viewed by other users of communication system 130 (besides the recipient of the message) is commonly known as a “post.” In one embodiment, a post is published within a feed of messages received by or otherwise accessible to one or more other users. In some embodiments, a user can publish a post or otherwise send a private message to another user that can only be retrieved by the other user.

When a user takes an action within communication system 130, the action may be recorded in action log 148 by action logger 126, subject to any privacy settings and restrictions of the user and/or communication system 130. In one embodiment, communication system 130 maintains action log 148 as a database of entries. When an action is taken on communication system 130, communication system 130 can add an entry for that action to action log 148. In accordance with various embodiments, action logger 126 is capable of receiving communications from web server 123 about user actions on and/or off communication system 130. Action logger 126 populates action log 148 with information about those user actions. This information may be subject to privacy settings associated with the user. Any action that a particular user takes with respect to another user is associated with each user's profile, through information maintained in a database or other data repository, such as action log 148. Examples of actions taken in communication system 130 that may be stored in action log 148 include, but are not limited to, adding a connection to another other user, creating a post or otherwise sending a message to another user, reading a message from the other user, viewing content (e.g., wall posts, images, videos) associated with or created by the other user, attending an event posted by another user, being tagged in photos with another user, etc. In some embodiments, certain actions are described in connection with more than one user, and these actions may be associated with those users as well and stored in action log 148.

Users may interact with various objects on communication system 130, including commenting on posts, sharing links, and checking-in to physical locations via a mobile device, accessing content items in a sequence or other interactions. Information describing these actions is stored in action log 148. Additional examples of interactions with objects on communication system 130 included in action log 148 include logging in to communication system 130, commenting on a photo album, communications between users, publishing the playback of a song, becoming a fan of a musician, politician, celebrity, or brand by “liking” a page of the respective entity, adding an event to a calendar, joining a group, creating an event, authorizing an application, using an application, and engaging in a transaction. Additionally, action log 148 records a user's interactions with advertisements on communication system 130 as well as other applications operating on communication system 130. In some embodiments, data from action log 148 is used to infer interests or preferences of the user, augmenting the interests included in the user profile, generating recommendations of other users or entities that may be of interest to the user, and allowing a more complete understanding of user preferences.

Action log 148 may be used by communication system 130 to track other user actions on communication system 130, as well as actions on external application 150 (e.g., website) that are communicated to the communication system 130. For example, communication system 130 may allow users to interact with external (e.g., third-party) applications 150 (e.g., websites), external storage 155, and/or external servers 115 (e.g., server end stations). API request server 125 allows external systems (e.g., external application 150 of external server 115, and/or user applications 105A of user devices 104A-104N) to access information from or transmit information to communication system 130 by issuing API calls. The information provided by communication system 130 may include user profile information or the connection information of users, subject to the individual privacy settings of the user. For example, a service or other system (e.g. external application 150) may send an API request to communication system 130 via network 121 to publish a story on behalf of a user (e.g., the user played a song, watched a movie), request information about a user (after having been given permission to do so by the user), upload a photograph on behalf of a user, etc. API requests are received at communication system 130 by API request server 125, which then processes the request by performing actions sought by the API requests, determining appropriate responses to the API requests, and transmitting back these responses back to requesting application 150 via network 121.

Content store 146 stores content items associated with user profiles, such as images, videos, and/or audio files. Content items from content store 146 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users or entities, to invite new users to the system or to increase interaction with communication system 130 by displaying content related to users, objects, activities, or functionalities of communication system 130. Examples of communication system content items include suggested connections or suggestions to perform other actions, media provided to or maintained by communication system 130 (e.g., photos, videos), status messages or links posted by users to communication system 130, events, groups, pages (e.g., representing an organization or commercial entity), and any other content provided by, or accessible via, communication system 130.

Content store 146 also includes one or more pages associated with entities included in social and civic graph store 140. An entity is a type of object that can be a non-individual user of communication system 130, such as a band, political office, political district, business, vendor, organization, university, etc. However, in some embodiments, an entity may represent a musician, politician, celebrity, or other well-known individual, and thus an entity object node for a person may exist in social graph and/or civic graph (serving as a “brand” for that individual, and perhaps having an associated page that other users may “like”) and also a user node for that same person may also exist in the social graph and/or civic graph (serving as a representation for a personal account of that person). A page includes content associated with an entity and instructions for presenting the content to a user of communication system 130. For example, a page identifies content associated with the entity's stored content (from object data store 154) as well as information describing how to present the content to users viewing the page.

In the depicted embodiment, communication system 130 includes civic graph generator 129 for generating a civic graph as described herein. In an alternate embodiment, civic graph generator 129 is a part of external server 115. For example, civic graph generator 129 may be implemented by external application 150.

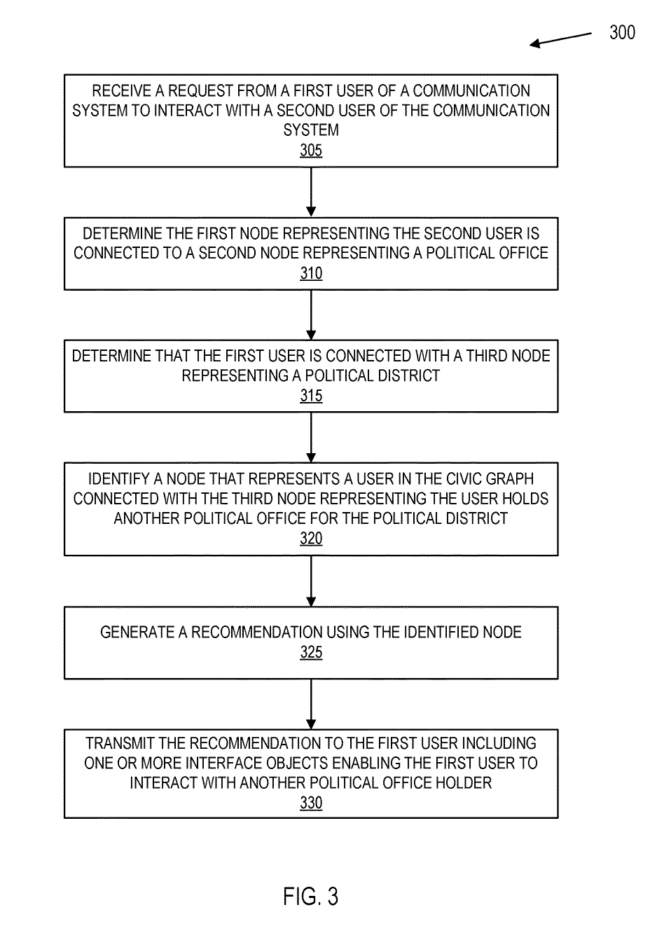

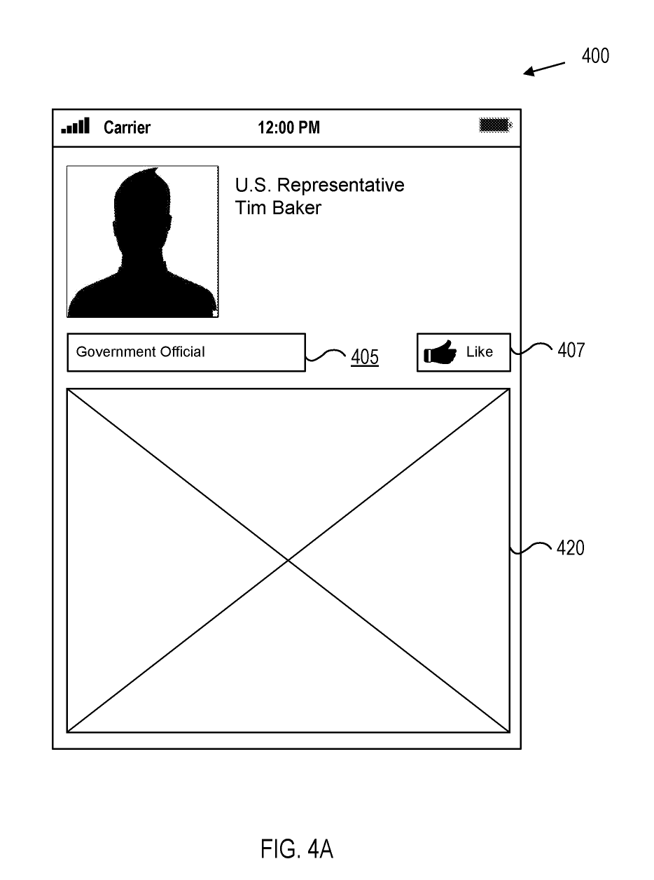

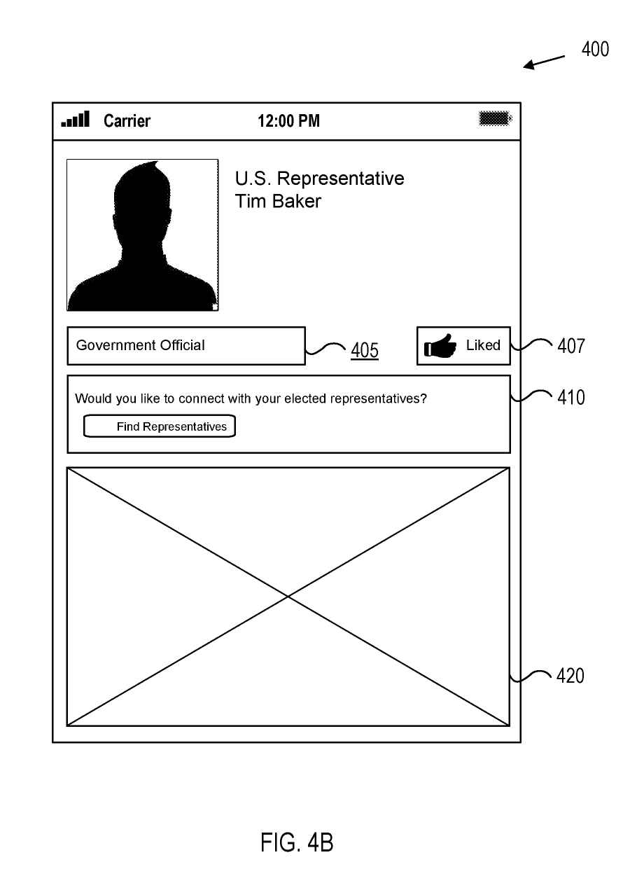

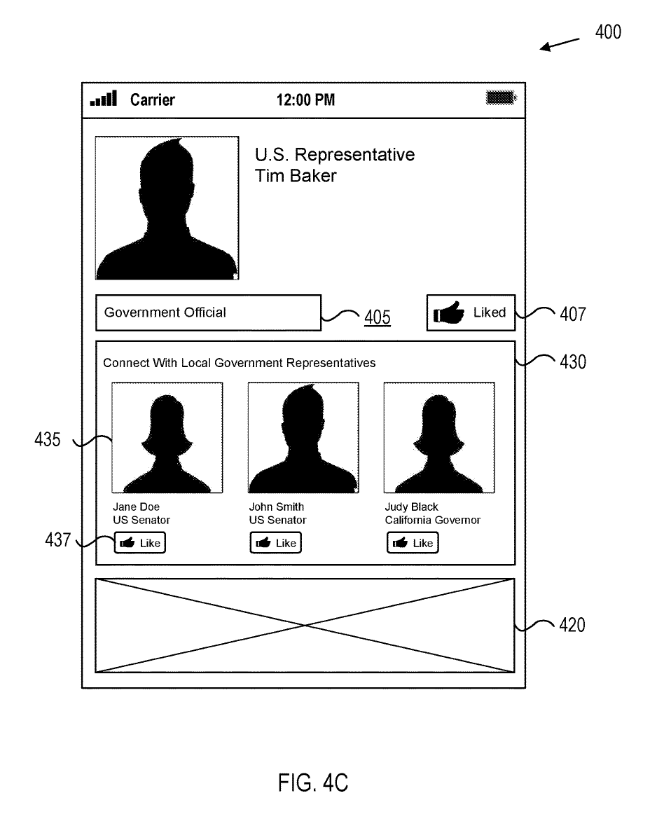

In one embodiment, civic graph generator 129 implements a method of generating and maintaining a civic graph of users of communication system 130. For example, civic graph generator 129 utilizes data that is descriptive of the user. The data is retrieved from the data stores 101. Based upon the descriptive data, civic graph generator 129 generates civic graph 250, as depicted in FIG. 2B. Civic graph generator 129 generates connections between users and objects within civic graph 250 based on user interactions with communication system 130. Based on the connections, civic graph generator 129 generates recommended connections for users of communication system 130 to connect with other objects and users in civic graph 250. An exemplary method of generating and transmitting recommendations enabling a user to interact with political office holders is described in greater detail with reference to FIGS. 3-4C.

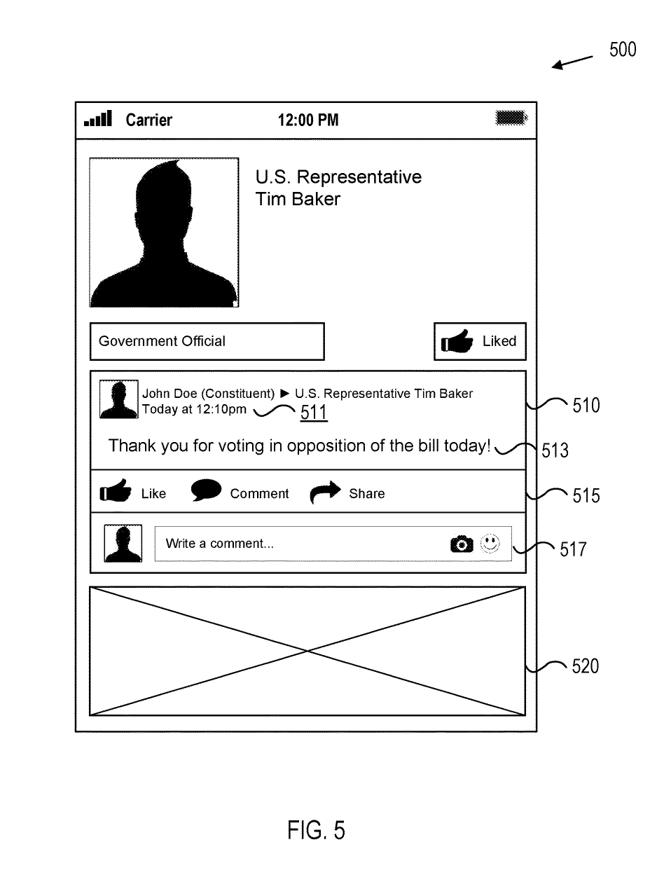

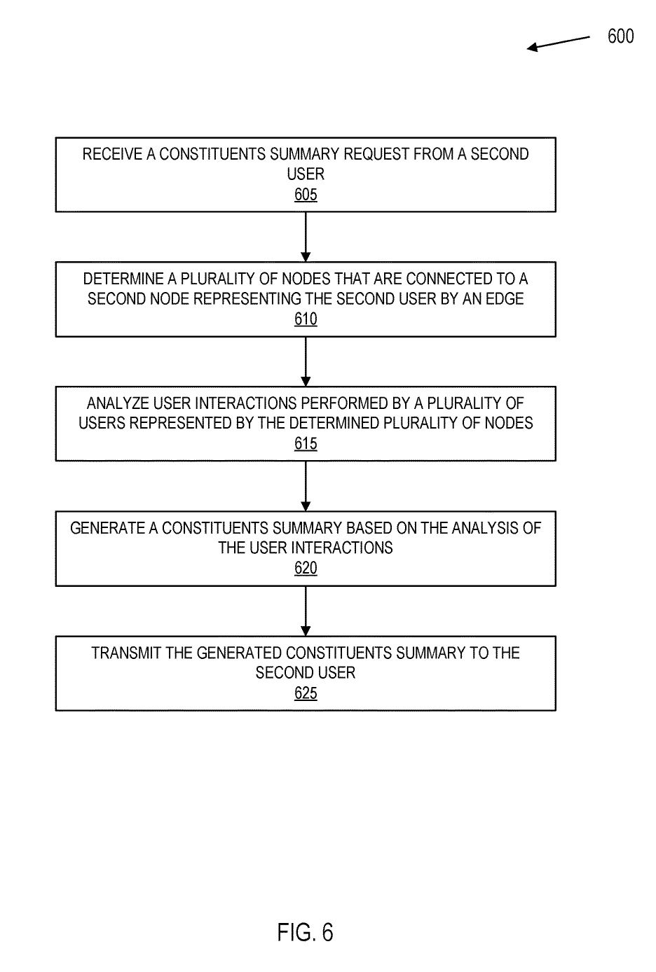

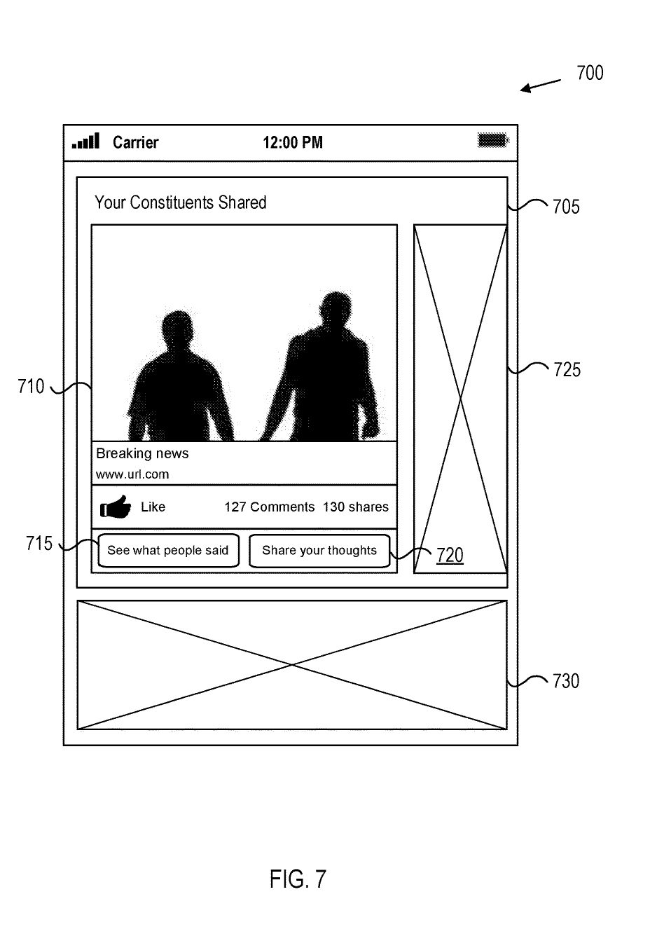

In one embodiment, civic graph generator 129 facilitates the generation and transmission of content between a political office holder and constituent users. Civic graph generator 129 enhances interactions from constituent users to the political office holder. An exemplary method of enhancing interactions from constituent users to the political office holder is described in greater detail with reference to FIG. 5. Civic graph generator 129 generates and transmits a constituents summary to the political officer holder. An exemplary method of generating and transmitting a constituents summary to the political officer holder is described in greater detail with reference to FIGS. 6-7.

In the depicted embodiment, communication system 130 also includes ballot generator 131 for generating and maintaining social ballots. In an alternate embodiment, ballot generator 131 is a part of external server 115. For example, ballot generator 131 may be implemented by external application 150.

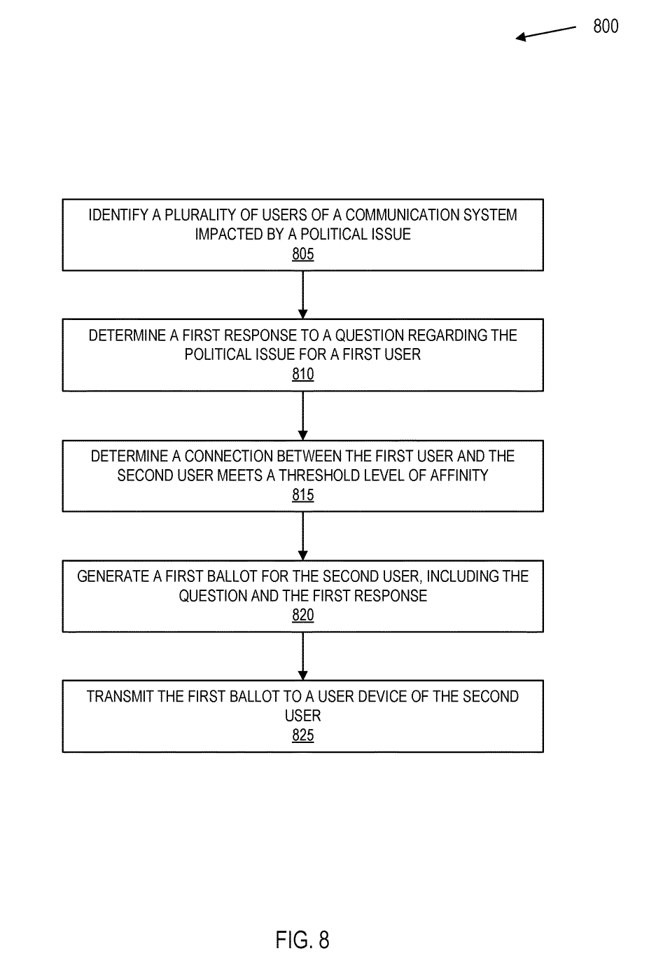

In one embodiment, ballot generator 131 implements a method of generating and transmitting a social ballot. Ballot generator 131 utilizes data that is descriptive of the user retrieved from the data stores 101, including a user location, interactions of the user with communication system 130, and interactions with communication system 130 by users connected to the user. Based upon the descriptive data, ballot generator 131 generates and/or modifies a social ballot for the user. For example, ballot generation 131 determines a plurality of users of communication system 130 impacted by a political issue, determines responses, implied or explicit, to a question regarding the political issue, and generates a ballot for a user that includes the question regarding the political issue and the determined responses to the question of users connected to the user. An exemplary method of generating and transmitting a social ballot is described in greater detail with reference to FIGS. 8-11.

FIG. 2A illustrates an exemplary social graph 200 of communication system data. In social graph 200, objects are illustrated as circles and actions are illustrated as labeled connections between circles. Developers of the communication system 130 or corresponding communication system applications define actions to represent different ways that users may interact with communication system 130 and/or their applications. As users perform actions, connections are made between users and objects. For example, User A has performed a number of actions within communication system 130, indicating that he previously lived in Boston, currently lives in Washington D.C., joined groups for Democrats and ConLaw Lovers, is following the White Sox, and is friends with User B. User B and User C have also performed a number of actions with respect to objects within graph 200.

In one embodiment, users are able to add demographic information to user profiles 205-215. In one embodiment, for demographic information that has not been entered by a user, a communication system application generates an estimate based upon the user's actions, connections, and/or actions of connections. For example, User B has not entered an alma mater into user profile 210. A communication system application may determine from User B's contacts, activities, cities of residence, etc. that User B's likely alma mater is one or both of Brigham Young University and Harvard University. In one embodiment, the user profiles 205-210 include additional information, such as relationships to other users, places where the user has worked, user interests, etc.

In one embodiment, users are able to provide feedback on actions of other users/entities. As a result, actions are also viewed as objects that may be acted upon. For example, User B listened to music by the artist, The Killers. As a result, communication system 130 publishes a narrative associated with User B (e.g., in a newsfeed, profile of User B, etc.) indicating that User B listened to music by the artist, The Killers. In viewing a newsfeed, profile of User B, or another form of communication system publication(s), communication system 130 displays the narrative to User A. Communication system 130 then receives input from User A indicating that User A “likes” that User B listened to The Killers.

In one embodiment, demographic data further includes a weight or score indicating an affinity between a user and an object. For example, repeated user action with one object may indicate a stronger affinity for said object than another object with which the user has limited interaction. First degree connections, e.g., the friendship between User A and User B, may indicate a stronger affinity than second degree connections, e.g., User A is friends with User B, who is friends with User C, creating a second degree connection between User A and User C. An indication that two users are married may indicate a stronger affinity than if two users are friends. Additionally, temporal and geographic proximity of actions/users are other exemplary indicators of affinity.

FIG. 2B illustrates an exemplary civic graph 250 of communication system data. In civic graph 250, objects are illustrated as circles (e.g., nodes) and actions and associations are illustrated as labeled connections (e.g., edges) between circles. Developers of communication system 130 or corresponding communication system applications define actions to represent different ways that users interact with communication system 130 and/or their applications. As users perform actions, connections are made between users and objects. For example, User D 255 has performed a number of actions within communication system 130, indicating that he lives in Political District “A” 285 and “likes” User E 260. User E 260, User F 265, and User G 270 have also performed a number of actions with respect to objects within civic graph 250.

Political districts may be defined in various sizes, including by state, county, congressional district, and city. Based on how political districts are defined, a user can be determined as residing in multiple political districts. Communication system 130 determines a user lives in a particular political district based on the user providing location data (e.g., address, zip code), using public records (e.g., government databases), or through other explicit means. In one embodiment, the determination is implicitly determined based on an analysis of content shared by the user within communication system 130. For example, communication system 130 may determine the user lives within a particular political district based on the user's history of location check-ins, sharing of content regarding local political issues, and/or sharing of content regarding local news. When the user's location is determined, the node representing the user can be associated with the nodes representing political districts that represent the user.

In one embodiment, users are able to perform actions indicating that they hold particular political offices. For example, User E 260 has performed an action indicating that they hold the political office of U.S. Congressman 275, and User F 265 has performed an action indicating that they hold the political office of State Governor 280. In some embodiments, communication system 130 receives a verification request from a user to verify that the user holds the political office, and performs a verification process to verify that the user holds the political office. The verification process includes verifying the name and address of the user, verifying government-issued identification of the user, etc. When the user is verified as the holder of the political office, communication system 130 modifies a permission setting for the user. For example, communication system 130 modifies a permission setting to enable the verified political office holder to be recommended to other users of communication system 130 (e.g., constituents), to receive constituent summaries, and to receive tagged content indicating that the content was shared with communication system 130 by users who are constituents of the verified political office holder. In one embodiment, the verified political office holder is granted permission to define the boundaries of the political district that the political office represents, e.g., by manipulating a set of one or more polygons on a map as a representation of the boundaries. In an alternate embodiment, a third party is granted permission and provided the capability to draw and edit the boundaries of the political district.

In one embodiment, the political office objects are further connected to the political district(s) that the political office represents. For example, the political office object of U.S. Congressman 275 has a connection to Political District “A” 285, as a representative of constituents residing within Political District “A.” Similarly, the political office object of State Governor 280 has connections to Political Districts “A” 285 and “B” 290, as a representative of constituents residing within Political District “A” and Political District “B.” For example, User F 265 holding the political office of State Governor 280 represents User D 255 and User E through the political office's representation of constituents in Political District “A” 285 and represents User G 270 through the political office's representation of constituents in Political District “B” 290. In one embodiment, the connections between the political offices and the political districts is user-initiated. In other embodiments, the connections between the political offices and the political districts is automatically created based on government-issued data (e.g., census data, redistricting guidelines, etc.).

FIG. 3 illustrates exemplary method 300 of generating and transmitting recommendations enabling a user to interact with political office holders. The operations of FIG. 3 will be described with reference to the exemplary embodiment of FIGS. 1-2B. However, it should be understood that the operations of FIG. 3 and the other flow diagrams can be performed by embodiments other than those discussed with reference to FIG. 1-2B.

At block 305, civic graph generator 129 receives a request from a first user of communication system 130 to interact with a second user of communication system 130. In one embodiment, the first user and the second user are represented in communication system 130 by nodes in a civic graph 250. As described previously, civic graph 250 includes a plurality of nodes and a plurality of edges, where each node represents one of a political district, a political office, a political office holder, and a constituent user. Each edge connecting two of the plurality of nodes represents an association or interaction between the connected nodes. Using the example of FIG. 2B, civic graph generator 129 receives a request from User D 255 to interact with User E 260. For example, User D 255 transmitted a request or instruction to “like,” “follow,” or otherwise connect with User E 260.

At block 310, civic graph generator 129 determines that the node representing the second user is connected to a node representing a political office by an edge, where the edge represents that the second user holds the political office represented by the node. Continuing the example of FIG. 2B, civic graph generator 129 determines that the node representing User E 260 is connected to the node representing the political office of U.S. Congressman 275.

At block 315, civic graph generator 129 optionally determines that the first user is connected with a node representing a political district. For example, using civic graph 250, civic graph generator 129 determines that User D 255 lives within Political District “A,” represented by node 285.

At block 320, civic graph generator 129 identifies a node that represents a third user in civic graph 250 connected with the node representing the political district, which indicates that the third user holds another political office for the political district. In one embodiment, the third user is directly connected to the node representing the political district by an edge, or is connected to the node representing the political district by an edge between the political office and the political district. For example, civic graph generator 129 identifies the node representing User F 265 as holding the political office of State Governor 280, which is connected with the node representing Political District “A” 285, indicating that User F 265 represents Political District “A.”

In an alternate embodiment, civic graph generator 129 identifies a node that represents a third user in civic graph 250, where the third user holds another political office that represents the first user. For example, the first user may also be represented in the civic graph as living in another political district that is distinct from Political District “A” 285. In one embodiment, political districts may be subsets of other political districts. In another embodiment, political districts may only partially overlap and, therefore, are represented independently of one another in civic graph 250.

In one embodiment, the third user is another political office holder that has been “liked” or “followed” by a plurality of users of communication system 130 that have also “liked” or “followed” the second user. In one embodiment, civic graph generator 129 identifies a node representing a third user that holds another political office and is a member of a same political party as the first user and/or the second user.

At block 325, civic graph generator 129 generates a recommendation using the identified node. At block 330, in response to the received request from the first user to interact with the second user, civic graph generator 129 transmits the recommendation to the first user. In one embodiment, the recommendation includes one or more interface objects. Each of the interface objects enables the first user to interact with another political office holder represented by a node in civic graph 250 that holds another political office determined to be within the political district that represents the first user. For example, civic graph generator 129 determines that User E 260 represents Political District “A,” and generates and transmits a recommendation to User D 255 to interact with User F 265 who holds a different political office, State Governor, which also represents Political District “A.” In response, civic graph generator 129 receives a request from User D 255 to interact with User F 265. For example, User D 255 selects a “Like” or “Follow” user interface object, such as user interface object 437 in FIG. 4C, causing civic graph generator 129 to create a connection (e.g., an edge) between User D 255 and User F 265 in civic graph 250. In another example, User D 255 requests to view a user profile of User F 265, by selecting user interface object 435 in FIG. 4C, causing communication system 130 to display the user profile of User F 265.

In one embodiment, the recommendation is generated and displayed on a user profile of the second user in response to the first user interacting with the second user. In other embodiments, the recommendation is transmitted to the first user via any other suitable means, including a message or email. In one embodiment, the recommendation is generated in response to the first user interacting with the second user, and is displayed to the first user in response to the first user providing an indication that recommendations are desired. In one embodiment, the recommendations are automatically generated and displayed in response to the user logging in to communication system 130. If another embodiment, the recommendations are automatically generated and displayed in response to the user accessing a user profile of the user or another user.

FIGS. 4A-4C each illustrate an exemplary user interface (UI) 400 for generating and transmitting recommendations enabling a user to interact with political office holders. FIG. 4A includes a first user's view of a user profile for a second user of communication system 130. In response to the first user requesting to access the user profile for the second user, communication system 130 displays the user profile on UI 400. In one embodiment, the user profile includes identification data (e.g., user photo, title, name) for the second user, and when the second user is a political office holder, text 405 that indicates that the user is a “Government Official.” The user profile for the user enables the first user to interact with the second user via button 407. Post 420 is currently visible within UI 400, and includes content from the user or one or more other users of communication system 130. Additional posts may be made visible in response to the user scrolling UI 400.

FIG. 4B illustrates UI 400 following an interaction by the first user with the user profile of the second user using button 407. In response to the first user interacting with the second user (e.g., “liking” the second user), communication system 130 modifies UI 400 to display user interface element 410. User interface element 410 prompts the first user with “Would you like to connect with your elected representatives?” The first user can select the button in user interface element 410 to indicate a response in the affirmative.

FIG. 4C illustrates UI 400 following an interaction by the first user with the button in user interface element 410. In response to the user indicating that they want to connect with additional elected representatives, communication system 130 replaces user interface element 410 or otherwise modifies UI 400 to display user interface element 430. User interface element 430 is a recommendation that includes a plurality of political office holders that represent the first user. In one embodiment, communication system 130 generates user interface element 430 in the manner described above with respect to FIG. 3. In one embodiment, there are a greater number or fewer number of political office holders presented to the first user. Each political office holder presented in user interface element 430 includes user identification data 435 (e.g., photo, name, title) and a button 437 allowing the first user to interact with the political office holder. For example, by selecting button 437, an edge is connected between a node representing the first user and a node representing U.S. Senator Jane Doe in the civic graph.

In one embodiment, user interface element 430 is generated in response to the first user interacting with button 407, and user interface element 430 is displayed to the first user in response to the first user providing an indication that recommendations are desired by selecting the button in user interface element 410. In another embodiment, user interface element 430 is automatically generated and displayed in response to the first user interacting with button 407 or otherwise interacting with the second user within the communication system. For example, communication system 130 may generate user interface element 430 in response to the first user transmitting a message to the second user or viewing content shared by the second user.

FIG. 5 illustrates an exemplary user interface (UI) 500 depicting interactions between a user and a political office holder. The embodiment of FIG. 5 is from the user's view of a user profile for the political office holder. In one embodiment, the user interacts with the political office holder by transmitting or posting a message or other content to a user profile feed. The post 510 includes content 513 (e.g., text, images, video), interaction buttons/elements 515, and text/multimedia field 517 for the political office holder to interact with post 510. Post 520 is currently visible within UI 500, and includes content from the user or one or more other users of communication system 130. Additional posts may be made visible in response to the user scrolling UI 500.

In one embodiment, post 510 includes an explicit indication in post header 511 indicating that the user is a “constituent” of the political office holder. When communication system 130 receives a user input from a first user for transmission to a second user, civic graph generator 129 determines the location of the user. In one embodiment, civic graph generator 129 determines if there is a connection in a civic graph between a node representing the user and a node representing a political district. When the node representing the user is connected to the node representing a particular political district, civic graph generator 129 determine if the political office holder holds a political office that represents the particular political district. Communication system 130 then generates a message that includes the user input from the first user. In some embodiments, when interactions are determined to be from a constituent of a political office holder, communication system 130 includes an indicator with the message. For example, in FIG. 5, the interaction (e.g., message post) by John Doe to U.S. Representative Tim Baker includes the indicator “(Constituent)” in post header 511 to denote that civic graph generator 129 determined that John Doe is a constituent of U.S. Representative Tim Baker. In other embodiments, the interaction is highlighted, given a higher priority in the political office holder's feed, or otherwise given a special notation, in order to encourage interactions and civic engagement between the political office holder and their constituents. In one embodiment, the political office holder transmits a targeted message or advertisement to specific users in civic graph 250. For example, a user that holds the political office of mayor for a city can send a targeted message to users in civic graph 250 that have a connection to a node representing the city, indicating that they reside in the city.

FIG. 6 illustrates exemplary method 600 of generating and transmitting a constituents summary. At block 605, communication system 130 receives a constituent summary request from a user. In one embodiment, the user is a political office holder. In one embodiment, the constituent summary request is automatically generated when the user logs into communication system 130 or when the user accesses a user profile associated with the user.

At block 610, communication system 130 determines a plurality of nodes that are each connected, directly or indirectly, to the node representing the user. The connections between the plurality of nodes and the node representing the user represents that the users represented by the plurality of nodes are constituents of the user. In one embodiment, one or more of the plurality of nodes are directly connected to the node representing the user via an edge. In other embodiments, one or more of the plurality of nodes are indirectly connected to the node representing the user via edges between the plurality of nodes and a node representing a political office or a political district and between the political office or the political district and the node representing the user. For example, referring back to FIG. 2, communication system 130 may determine one or more users live within Political District “A” and, therefore, are indirectly connected to User E 260 that holds a political office that represents Political District “A.”

At block 615, communication system 130 analyzes user interactions performed by a plurality of users represented by the determined plurality of nodes. The user interactions include sharing content or interacting with content shared via communication system 130. In one embodiment, communication system 130 analyzes the user interactions to identify content shared via communication system 130 by a number of users. In one embodiment, communication system 130 identifies a post that has been “liked” or “shared” by a number of users above a predetermined threshold number. For example, if an article shared via communication system 130 has been posted, shared, or commented on by greater than ten constituents of a political office holder, the article may be flagged. In one embodiment, communication system 130 analyzes the text of postings and comments made by the plurality of users to identify words, concepts, or topics that are being discussed. For example, communication system 130 may analyze the text and/or comments to determine trending issues among constituents.

At block 620, communication system 130 generates a constituents summary based on the analysis of the user interactions performed by the determined plurality of users. In one embodiment, the constituents summary indicates trending issues among the constituents of the political office held by the political office holder. In one embodiment, the constituents summary includes articles and postings, as well as general topics based on textual analysis of postings and comments made by the plurality of users. In one embodiment, communication system 130 filters postings and comments based upon the identified words, concepts, or topics. For example, the constituents summary may filter content unrelated to political matters. In one embodiment, communication system 130 identifies concepts or topics meeting a predetermined threshold level of activity, such as a minimum number of users, posts, comments, or other user interactions. In such embodiments, communication system 130 selects a subset of the identified concepts of topics for display in the constituents summary.

At block 625, communication system 130 transmits the generated constituents summary to the user. The generated constituents summary is displayed as a message, in a feed, or other presentation for the user.

FIG. 7 illustrates an exemplary user interface 700 displaying a constituents summary. User interface 700 includes constituent summary section 705 that is comprised of a plurality of posts. Post 710 includes content, including photographs, a link, and a summary of the content. Post 710 also includes interface objects enabling the user to interact with post 710. For example, button 715, when selected, displays comments made by constituents of the user regarding the content. In one embodiment, communication system 130 uses a filtering method to exclude comments and user interactions made by non-constituent users of communication system 130. Button 720, when selected, allows the user to engage with their constituents by providing their own comments regarding the content. In one embodiment, communication system generates an alert or notification message indicating that the user has provided a comment or other user interaction to a post in the constituents summary. For example, a constituent user receives a notification message indicating that a political officer holder that represents the constituent user posted a reply to a post in the constituents summary. Post 725 is currently visible within UI 700, and includes additional content determined by the communication system 130 to include in the constituents summary. Post 730 is also currently visible within UI 700. Additional posts may be made visible in response to the user scrolling UI 700.

FIG. 8 illustrates an exemplary method 800 of generating and transmitting a social ballot. At block 805, ballot generator 131 identifies a plurality of users of communication system 130 impacted by a political issue, including a first user and a second user. In one embodiment, ballot generator 131 determines the political issue impacts a geographic region. Ballot generator 131 then identifies the plurality of users of communication system 130 that can be determined as living in the geographic region. For example, ballot generator 131 determines that Proposition 1 affects a particular county and identifies the users of communication system 130 that reside in the particular county. In one embodiment, ballot generator 131 determines that a political issue impacts a particular political district and accesses civic graph 250. In such an embodiment, ballot generator 131 identifies the nodes representing users of communication system 130 that have an edge connecting to the node representing the particular political district. In one embodiment, a political issue may also be represented by a node in civic graph 250. In one embodiment, civic graph 250 includes edges connecting the node representing the political issue to nodes representing particular political districts impacted by the political issue.

At block 810, ballot generator 131 determines a first response to a question regarding the political issue for the first user. In one embodiment, determining the first response includes receiving an explicit response to the question from the first user or determining an implied response for the first user. Determining the explicit response to the question from the first user includes transmitting a ballot including the question to the first user and receiving the explicit response to the question submitted by the first user in response. Determining the implied response to the question from the first user includes selecting content shared via communication system 130 by the first user by determining the selected content is related to the political issue. In one embodiment, ballot generator 131 identifies posts and other content shared by the first user on a first user profile. Ballot generator 131 then determines the implied response to the question for the first user by analyzing the selected content. In one embodiment, ballot generator 131 performs a text recognition analysis to determine words posted by the first user that is used to determine the first user's sentiment with regards to the question. In one embodiment, the implied or explicit response is determined using data obtained from third party sources. In one embodiment, ballot generator 131 sends a confirmation request message to the first user including the determined implied response and receives a confirmation response message from the first user either confirming or rejecting the implied response. In one embodiment, ballot generator 131 may retrieve the first response to the question from user profile data store 152.

At block 815, ballot generator 131 determines a connection between the first user the second user within communication system 130 meets a threshold level of affinity. In one embodiment, the threshold level of affinity is reached when the first user and the second user are friends or otherwise directly connected within communication system 130. In other embodiments, the threshold level of affinity is reached when the first user is at least a friend of a friend of the second user or otherwise indirectly connected within communication system 130. In one embodiment, the responses of the second user of communication system 130 are not included when the threshold level of affinity with the first user is not reached.

In one embodiment, ballot generator 131 determines if there is a connection (e.g., edge) between a node representing the first user and a node representing the second user in civic graph 250. The presence of a connection between the nodes in civic graph 250 indicates that the first user and second user are friends or have previously interacted within communication system 130.

At block 820, ballot generator 131 generates a ballot for the second user. In one embodiment, the ballot includes the question regarding the political issue and the determined first response for the first user. For example, the ballot for the second user may include identification information for the first user (e.g., name, user name, photo), the first user's response to the question, and any other content shared by the first user within communication system 130.

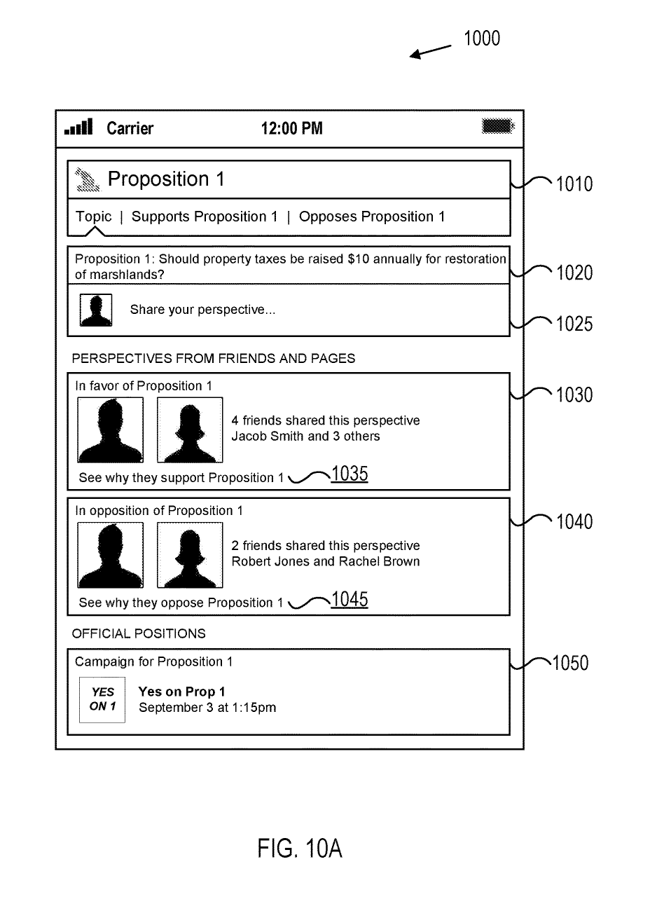

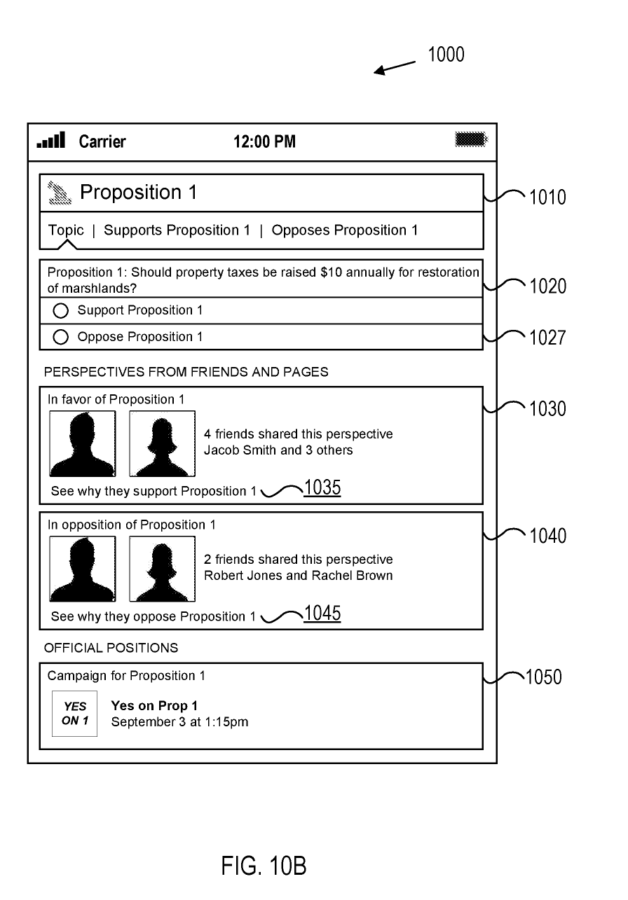

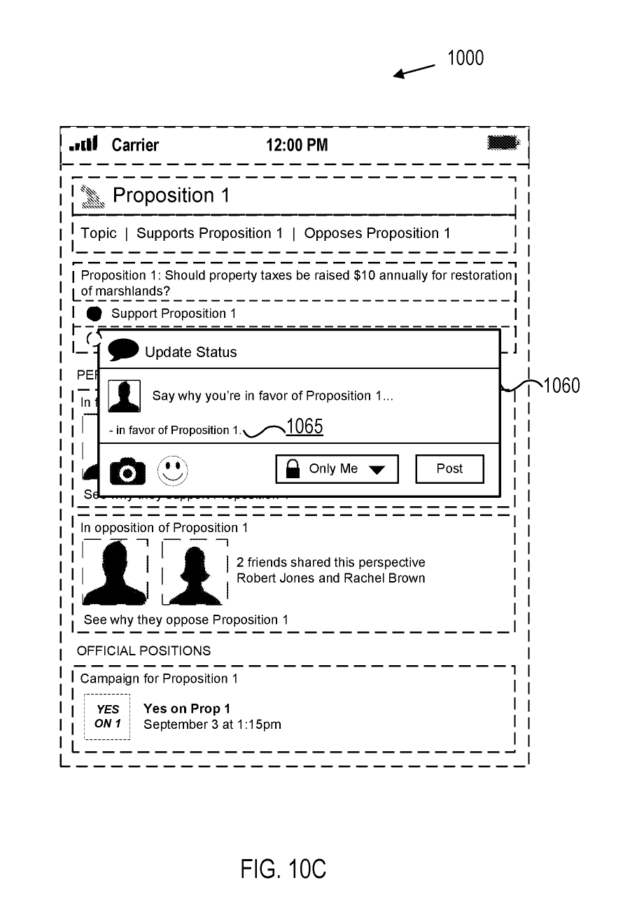

At block 825, ballot generator 131 transmits the ballot to the second user for display. Ballot generator 131 subsequently receives a response to the question from the second user and additional user input. The additional user input may include content, such as text, photographs and/or other multimedia content. In response, a post to communication system 130 is generated that indicates the response from the second user and includes the additional user input received from the second user. An exemplary first ballot including the determined response from the first user is depicted in FIG. 10A, described herein.

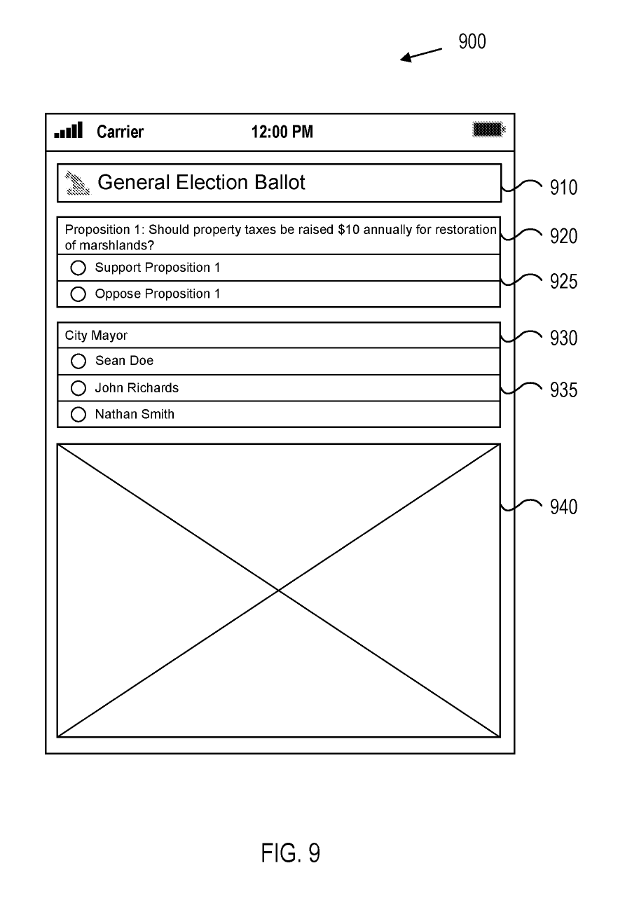

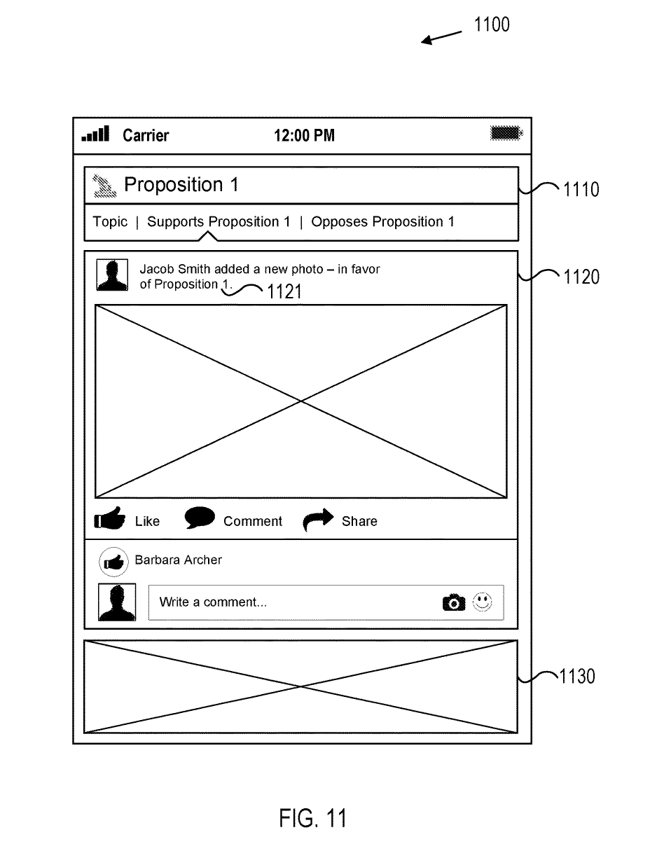

FIGS. 9-11 each illustrate an exemplary UI for generating and transmitting a social ballot. FIG. 9 illustrates an exemplary UI 900 depicting a social ballot displayed by communication system 130. UI 900 includes a ballot header 910 indicating that the social ballot is a “General Election Ballot.” The social ballot includes one of more ballot questions 920, 930. For example, ballot question 920 states: “Proposition 1: Should property taxes be raised $10 annually for restoration of marshlands?” Ballot question 930 states: “City Mayor.” Each of ballot question 920 and 930 includes one or more user-selectable options 925, 935, for responding to the respective ballot questions. Additional ballot question 940 is also currently visible within UI 900. Additional posts may be made visible in response to the user scrolling UI 900. In one embodiment, the ballot questions are interface objects that enable a user to select the ballot question for additional information, as depicted in FIGS. 10A-11. In one embodiment, the ballot questions included in a particular social ballot are uniquely determined for the user based on a determination of political issues impacting the user.

FIG. 10A illustrates exemplary UI 1000 to enable a user to interact with a plurality of users of communication system 130 that are also impacted by a political issue. In one embodiment, UI 1000 is displayed in response to the user selecting ballot question 920 in FIG. 9. In one embodiment, UI 1000 is a new window or tab opened in response to the user selecting ballot question 920. In one embodiment, UI 1000 is a ballot question summary page that includes ballot question header 1010, ballot question 1020, user interface object 1025 that allows the user the interact with communication system 130, first option summary 1030, second option summary 1040, and ballot question information 1050. In one embodiment, in response to a user interacting with user interface object 1025, e.g., by selecting user interface object 1025, communication system 130 replaces user interface object 1025 with user interface object 1027 to allow the user to make a selection from the ballot question options, as shown in FIG. 10B. In one embodiment, user interface object 1025 is a text box that the user can interact it to share their perspective on the ballot question.

In one embodiment, first option summary 1030 includes identification information (e.g., photographs, user names) of a plurality of users of communication system 130 connected to the user that ballot generator 131 has determined share the perspective of the first option to ballot question 1020. In one embodiment, first option summary 1030 includes a user interface object 1035 (e.g., selectable text, image) that enables the user to interact with content shared by the plurality of users of communication system 130 connected to the user that share the perspective of the first option to ballot question 1020. For example, in response to selection of user interface object 1035, communication system 130 overlays a pop-up box that includes posts shared by the plurality of users of communication system 130 connected to the user that shared the perspective of the first option to ballot question 1020. In another example, in response to selection of user interface object 1035, communication system 130 displays UI 1100, as described with respect to FIG. 11. In one embodiment, second option summary 1040 includes similar information as first option summary 1030, including a user interface object 1045 that enables the user to interact with content shared by the plurality of users of communication system 130 connected to the user that share the perspective of the second option to ballot question 1020.

Ballot question information 1050 includes one or more pages or profiles within communication system 130 associated with each of the response options to ballot question 1020. For example, ballot question information 1050 includes an interface object enabling the user to access a profile within communication system 130 containing official information regarding the ballot question. For example, a profile in support of one option of the ballot question may be verified through a verification process as being an official sponsor of the ballot question. In one embodiment, the profile may be associated with a political party or political office holders supporting the ballot question option.

FIG. 10B illustrates exemplary UI 1000 to enable a user to interact with a plurality of users of communication system 130 that are also impacted by a political issue. In FIG. 10B, in response to the user selecting interface object 1025 in FIG. 10A, ballot question options 1027 is presented to allow the user the interact with communication system 130.

FIG. 10C illustrates exemplary UI 1000 to enable a user to interact with a plurality of users of communication system 130 that are also impacted by a political issue. In response to the user selecting one of the ballot question options 1027 in FIG. 10B (e.g., “Support Proposition 1”), pop-up box 1060 is presented to the user to allow the user to interact with communication system 130 by sharing content with respect to the ballot question option selected. In one embodiment, pop-up box 1060 includes tag 1065 that is appended to the content shared by the user to indicate that the content is in response to the user's ballot question option selection. For example, the user, having selected “Support Proposition 1” is presented with pop-up box 1060, which will include the text, “in favor of Proposition 1” with the content provided by the user to communication system 130.

FIG. 11 illustrates exemplary UI 1100 to enable a user to interact with a plurality of users of communication system 130 that are also impacted by a political issue. In response to the user selecting “Supports Proposition” in ballot question header 1110, ballot generator 131 displays a communication system feed containing content shared by users of communication system 130 that are determined to be in support of Proposition 1. For example, post 1120 includes content shared by user Jacob Smith. Post 1120 includes tag 1121 indicating that the content shared is related to the Jacob Smith's support of Proposition 1. Additional post 1130 is also currently visible within UI 1100. Additional posts may be made visible in response to the user scrolling UI 1100.

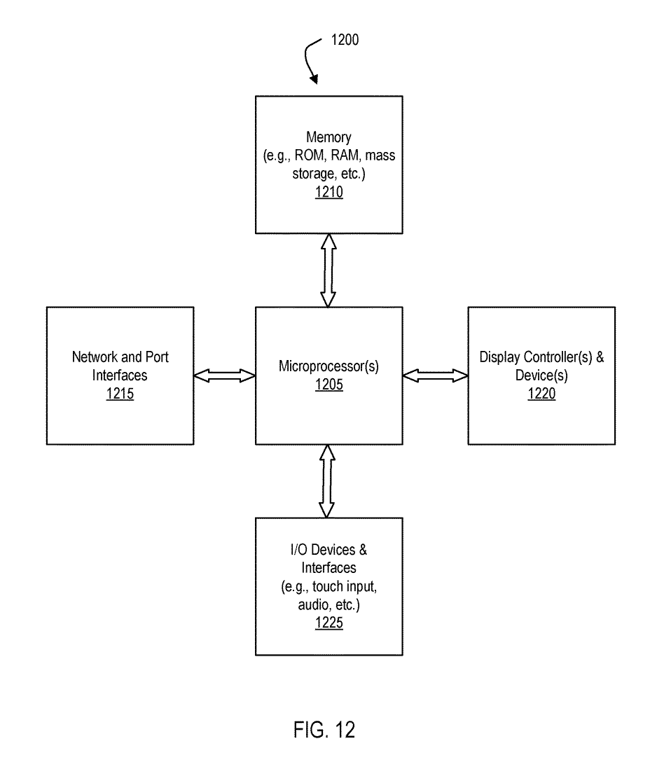

FIG. 12 illustrates, in block diagram form, exemplary processing system 1200 to generate civic graphs and social ballots. Data processing system 1200 is an exemplary representation of one or more of user devices 104A-104N, external server 115, communication system 130, or components thereof.

Data processing system 1200 includes one or more microprocessors 1205 and connected system components (e.g., multiple connected chips). Alternatively, data processing system 1200 is a system on a chip.

Data processing system 1200 includes memory 1210, which is coupled to microprocessor(s) 1205. Memory 1210 may be used for storing data, metadata, and programs for execution by the microprocessor(s) 1205. For example, memory 1210 may include one or more of the data stores 101 and/or may store modules, such as civic graph generator 129 and ballot generator 132, described herein. Memory 1210 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1210 may be internal or distributed memory.

Data processing system 1200 includes network and port interfaces 1215, such as a port, connector for a dock, or a connector for a USB interface, FireWire, Thunderbolt, Ethernet, Fibre Channel, etc. to connect the system 1200 with another device, external component, or a network. Exemplary network and port interfaces 1215 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect data processing system 1200 with another device, external component, or a network and receive stored instructions, data, tokens, etc.

Data processing system 1200 also includes display controller and display device 1220 and one or more input or output (“I/O”) devices and interfaces 1225. Display controller and display device 1220 provides a visual user interface for the user. I/O devices 1225 allow a user to provide input to, receive output from, and otherwise transfer data to and from the system. I/O devices 1225 may include a mouse, keypad or a keyboard, a touch panel or a multi-touch input panel, camera, optical scanner, audio input/output (e.g., microphone and/or a speaker), other known I/O devices or a combination of such I/O devices. One or more buses may be used to interconnect the various components shown in FIG. 12.

Data processing system 1200 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, data processing system 1200 may be a network computer, server, or an embedded processing device within another device or consumer electronic product. As used herein, the terms computer, device, system, processing system, processing device, and “apparatus comprising a processing device” may be used interchangeably with data processing system 1200 and include the above-listed exemplary embodiments.

Additional components, not shown, may also be part of data processing system 1200, and, in certain embodiments, fewer components than that shown in FIG. 12 may also be used in data processing system 1200. It will be apparent from this description that aspects of the invention(s) may be embodied, at least in part, in software. That is, the computer-implemented methods 300, 600 and 800 may be carried out in a computer system or other data processing system 1200 in response to its processor or processing system 1205 executing sequences of instructions contained in a memory, such as memory 1210 or other non-transitory machine-readable storage medium. The software may further be transmitted or received over a network (not shown) via network interface device 1215. In various embodiments, hardwired circuitry may be used in combination with the software instructions to implement the present embodiments. Thus, the techniques are not limited to any specific combination of hardware circuitry and software, or to any particular source for the instructions executed by data processing system 1200.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method comprising:
receiving a request from a first user of a communication system to interact with a second user of the communication system, the second user being represented in the communication system by a first node of a civic graph, the civic graph including a plurality of nodes and a plurality of edges, each node in the plurality of nodes representing one of a political district, a political office, and a political office holder, and each edge in the plurality of edges connecting two of the plurality of nodes to represent an association between the connected nodes;
determining the first node representing the second user is connected to a second node representing a political office by a first edge, the first edge representing that the second user holds the political office represented by the second node; and
in response to the received request and the determination that the second user holds the political office, transmitting a recommendation to the first user, the recommendation including one or more interface objects, each of the interface objects enabling the first user to interact with another political office holder represented by a node in the civic graph that holds another political office determined to be within the political district that represents the first user.

2. The computer-implemented method of claim 1, wherein transmitting the recommendation to the first user comprises:
determining that the first user is connected with a third node representing the political district;
identifying a node that represents a user in the civic graph and is connected with the third node by a second edge representing the user holds the another political office for the political district; and
generating the recommendation, the recommendation using the identified node.

3. The computer-implemented method of claim 1, further comprising:
receiving a user input from the first user for transmission to the second user;
determining that a third node representing the first user is connected with the second node by a second edge representing the first user is a constituent of the political office;
generating a message including the user input from the first user and, in response to determining the first user is a constituent of the political office, indicating that the message is from a constituent of the political office held by second user; and
transmitting the message to the second user.

4. The computer-implemented method of claim 1, further comprising:
receiving a constituents summary request from the second user;
determining, in response to the constituents summary request, a plurality of nodes that are each connected to the second node by an edge representing the user is a constituent of the political office;
analyzing user interactions performed by a plurality of users represented by the determined plurality of nodes, the user interactions including sharing content or interacting with content shared via the communication system;
generating a constituents summary based on the analysis of the user interactions performed by the determined plurality of users; and
transmitting the generated constituents summary to the second user.

5. The computer-implemented method of claim 4, wherein the constituents summary indicates trending issues among the constituents of the political office.

6. The computer-implemented method of claim 1, further comprising:
receiving a verification request from the second user to verify that the second user holds the political office;
determining, in response to receiving the verification request, that the second user holds the political office by a verification process; and
modifying, in response to determining the second user holds the political office, a permission for the second user.

7. The computer-implemented method of claim 6, wherein modifying the permission for the second user includes enabling the second user to be eligible for inclusion in the recommendation transmitted to the first user.

8. A non-transitory computer-readable medium storing instructions which, when executed by one or more processors in a processing device, cause the processing device to perform a method comprising:
receiving a request from a first user of a communication system to interact with a second user of the communication system, the second user being represented in the communication system by a first node of a civic graph, the civic graph including a plurality of nodes and a plurality of edges, each node in the plurality of nodes representing one of a political district, a political office, and a political office holder, and each edge in the plurality of edges connecting two of the plurality of nodes to represent an association between the connected nodes;
determining the first node representing the second user is connected to a second node representing a political office by a first edge, the first edge representing that the second user holds the political office represented by the second node; and
in response to the received request and the determination that the second user holds the political office, transmitting a recommendation to the first user, the recommendation including one or more interface objects, each of the interface objects enabling the first user to interact with another political office holder represented by a node in the civic graph that holds another political office determined to be within the political district that represents the first user.

9. The non-transitory computer-readable medium of claim 8, wherein transmitting the recommendation to the first user comprises:
determining that the first user is connected with a third node representing the political district;
identifying a node that represents a user in the civic graph and is connected with the third node by a second edge representing the user holds the another political office for the political district; and
generating the recommendation, the recommendation using the identified node.

10. The non-transitory computer-readable medium of claim 8, further comprising:
receiving a user input from the first user for transmission to the second user;
determining that a third node representing the first user is connected with the second node by a second edge representing the first user is a constituent of the political office;
generating a message including the user input from the first user and, in response to determining the first user is a constituent of the political office, indicating that the message is from a constituent of the political office held by second user; and
transmitting the message to the second user.

11. The non-transitory computer-readable medium of claim 8, further comprising:
receiving a constituents summary request from the second user;
determining, in response to the constituents summary request, a plurality of nodes that are each connected to the second node by an edge representing the user is a constituent of the political office;
analyzing user interactions performed by a plurality of users represented by the determined plurality of nodes, the user interactions including sharing content or interacting with content shared via the communication system;
generating a constituents summary based on the analysis of the user interactions performed by the determined plurality of users; and
transmitting the generated constituents summary to the second user.

12. The non-transitory computer-readable medium of claim 11, wherein the constituents summary indicates trending issues among the constituents of the political office.

13. The non-transitory computer-readable medium of claim 8, further comprising:
receiving a verification request from the second user to verify that the second user holds the political office;
determining, in response to receiving the verification request, that the second user holds the political office by a verification process; and
modifying, in response to determining the second user holds the political office, a permission for the second user, the modification including enabling the second user to define boundaries of the political district.

14. The non-transitory computer-readable medium of claim 13, wherein enabling the second user to define the boundaries of the political district includes enabling the second user to manipulate a set of one or more polygons on a map as a representation of the boundaries.

15. An apparatus comprising:
a processing device; and
a memory coupled to the processing device, the memory storing instructions which, when executed by the processing device, cause the apparatus to:
receive a request from a first user of a communication system to interact with a second user of the communication system, the second user being represented in the communication system by a first node of a civic graph, the civic graph including a plurality of nodes and a plurality of edges, each node in the plurality of nodes representing one of a political district, a political office, and a political office holder, and each edge in the plurality of edges connecting two of the plurality of nodes to represent an association between the connected nodes;
determine the first node representing the second user is connected to a second node representing a political office by a first edge, the first edge representing that the second user holds the political office represented by the second node; and
in response to the received request and the determination that the second user holds the political office, transmit a recommendation to the first user, the recommendation including one or more interface objects, each of the interface objects enabling the first user to interact with another political office holder represented by a node in the civic graph that holds another political office determined to be within the political district that represents the first user.

16. The apparatus of claim 15, wherein transmitting the recommendation to the first user causes the apparatus to:
determine that the first user is connected with a third node representing the political district;
identify a node that represents a user in the civic graph and is connected with the third node by a second edge representing the user holds the another political office for the political district; and
generate the recommendation, the recommendation using the identified node.

17. The apparatus of claim 15, wherein the instructions further cause the apparatus to:
receive a user input from the first user for transmission to the second user;
determine that a third node representing the first user is connected with the second node by a second edge representing the first user is a constituent of the political office;
generate a message including the user input from the first user and, in response to determining the first user is a constituent of the political office, indicating that the message is from a constituent of the political office held by second user; and
transmit the message to the second user.

18. The apparatus of claim 15, wherein the instructions further cause the apparatus to:
receive a constituents summary request from the second user;
determine, in response to the constituents summary request, a plurality of nodes that are each connected to the second node by an edge representing the user is a constituent of the political office;
analyze user interactions performed by a plurality of users represented by the determined plurality of nodes, the user interactions including sharing content or interacting with content shared via the communication system;
generate a constituents summary based on the analysis of the user interactions performed by the determined plurality of users; and
transmit the generated constituents summary to the second user.

19. The apparatus of claim 18, wherein the constituents summary indicates trending issues among the constituents of the political office.

20. The apparatus of claim 15, wherein the instructions further cause the apparatus to:
receive a verification request from the second user to verify that the second user holds the political office;
determine, in response to receiving the verification request, that the second user holds the political office by a verification process; and
modify, in response to determining the second user holds the political office, a permission for the second user, the modification including enabling the second user to define boundaries of the political district.
